(19) United States
(12) Patent Application Publication
(10) Pub. No.: US 2015/0064978 A1
(43) Pub. Date: Mar. 5, 2015

(54) CONNECTOR TAPE AND CONNECTOR MODULE THEREOF

(71) Applicant: BELLWETHER ELECTRONIC CORP., Taoyuan County (TW)

(72) Inventors: Kuan-Wu CHEN, TAOYUAN COUNTY (TW); Hsing-Yu LEE, TAOYUAN COUNTY (TW)

(21) Appl. No.: 14/329,319

(22) Filed: Jul. 11, 2014

(30) Foreign Application Priority Data
Aug. 28, 2013 (TW) 102216162

(51) Int. Cl. H01R 24/76

(52) U.S. Cl. CPC H01R 24/76
USPC 439/656

(57) ABSTRACT

A connector tape and a connector module thereof is disclosed. The connector module includes a connector and a detachable counter weight block. The connector includes an insulative main body and a plurality of conductive terminals secured onto the insulative main body. Each conductive terminal includes a soldering portion exposed on the insulative main body. The detachable counter weight block is detachably connected to the insulative main body and exerts a gravitational force on the soldering portions via the insulative main body. Therefore, during the process of assembly of the connector and circuit board, the detachable counter weight block exerts a gravitational force on the soldering portions for stably soldering the soldering portion onto the circuit board; also, once the assembly is complete, the detachable counter weight block can be detached from the insulative main body with ease such that the assembly is of low costs with simplified steps.

### BACKGROUND OF THE INVENTION

1. Field of the Invention

The present invention is related to a connector, in particular, to a connector tape and a connector module thereof.

2. Description of Related Art

Latch connectors are available in the market and are used for installing onto the edges of printed circuit boards. Such type of latch connector typically comprises an insulative main body and a plurality of conductive terminals secured onto the insulative main body; each conductive terminal includes a soldering portion exposed on the insulative main body; each soldering portion is soldered onto the edge of the printed circuit board correspondingly.

In a conventional soldering method for the soldering portion and the printed circuit board, such as the one disclosed in U.S. Pat. No. 5,860,815, the circuit board includes a receiving hole, and a circuit area and a redundant area are formed at the inner and outer of the receiving hole corresponding to the circuit board, followed by placing the latch connector into the receiving hole in order to allow the soldering portion to be soldered onto the edge of the circuit area correspondingly. Finally, the redundant area is trimmed off in order to complete a finishing product.

However, to prevent the latch connector placed inside the receiving hole from tilting forward, a supporting portion is required to be formed at the redundant area in order to allow the soldering portion to be stably attached to the edge of the circuit area. In addition, once the soldering is complete, there is a need of the extra process of trimming the redundant area off. Therefore, for the assembly of the latch connector, there are at least problems of increased costs and complicated steps.

In view of the above, the inventor seeks to overcome the aforementioned drawbacks of the currently existing technique and provides an improvement after years of research and development along with the use of academic principles in light of solving the aforementioned problems.

### SUMMARY OF THE INVENTION

An objective of the present invention is to provide a connector tape and a connector module, utilizing a detachable counter weight block to be detachably connected to the insulative main body such that during the process the assembly of the connector and the circuit board, the detachable counter weight block can exert a gravitational force of weight on the soldering portions in order to allow the soldering portion to be stably soldered onto the circuit board. In addition, after the assembly of the connector and the circuit board is complete, the detachable counter weight block can be easily detached from the insulative main body; therefore, the advantages of providing a connector assembly that is cost-saving with simplified steps can be achieved.

To achieve the aforementioned objective, the present invention provides a connector module comprising:

a connector comprising an insulative main body and a plurality of conductive terminals secured on the insulative main body; each one of the conductive terminals having a soldering portion exposed out of the insulative main body; and

a detachable counter weight block detachably connected to the insulative main body; the detachable counter weight block configured to exert a gravitational force of weight on the plurality of soldering portions via the insulative main body.

To achieve the aforementioned objective, the present invention provides a connector tape comprising:

a substrate having a plurality of receiving slots; and

a plurality of connector module as mentioned above; each connector module respectively received and sealed inside each receiving slot.

The present invention further includes the following advantageous effects:

First, when the detachable counter weight block is assembled onto the insulative main body, the detachable counter weight block is able to exert a gravitational force of weight on the soldering portion in order to allow the soldering portion and the corresponding contact points can be firmly soldered onto each other such that a simple unit can be used to facilitate the assembly of the connector and the circuit board; therefore, the connector module of the present invention has the merits of low assembly cost.

Second, once the connector and the circuit board are assembled completely, the assembly personnel can easily detach the detachable counter weight block from the insulative main body in order to complete the finishing product such that simple steps are used to complete the assembly of the connector and the circuit board; therefore, the connector module of the present invention has the merits of simplified steps for assembly.

Third, the detachable counter weight block detached from the connector module can be re-used; by assembling the detachable counter weight block onto another connector, another new connector module can be formed; therefore, the assembly cost of the connector module of the present invention is even cheaper.

Fourth, the manufacturer can ship the connector tapes to the customer in order to facilitate the planning of the storage, shipping and management of the connector modules.

### BRIEF DESCRIPTION OF DRAWING

FIG. 1 is an exploded view of the first embodiment of the connector module of the present invention;

FIG. 2 is a perspective assembly view of the first embodiment of the connector module of the present invention;

FIG. 3 is a cross s sectional assembly view of the first embodiment of the connector module of the present invention;

FIG. 4 is an illustration showing a state of use of first embodiment of the connector module of the present invention;

FIG. 5 is an illustration showing another state of use of first embodiment of the connector module of the present invention;

FIG. 6 is a perspective assembly view of the connector tape of the present invention;

FIG. 7 is an exploded view of the second embodiment of the connector module of the present invention;

FIG. 8 is a cross sectional assembly view of the second embodiment of the connector module of the present invention;

FIG. 9 is an exploded view of the third embodiment of the connector module of the present invention;

FIG. 10 is a cross sectional assembly view of the third embodiment of the connector module of the present invention;

FIG. 11 is an exploded view of the fourth embodiment of the connector module of the present invention; and

FIG. 12 is a cross sectional assembly view of the fourth embodiment of the connector module of the present invention.

### DETAILED DESCRIPTION OF THE INVENTION

The following provides a detailed description of the present invention along with the accompanied drawings; however, it shall be understood that the accompanied drawings are provided for illustrative purposes only, which shall not be treated as limitations of the present invention.

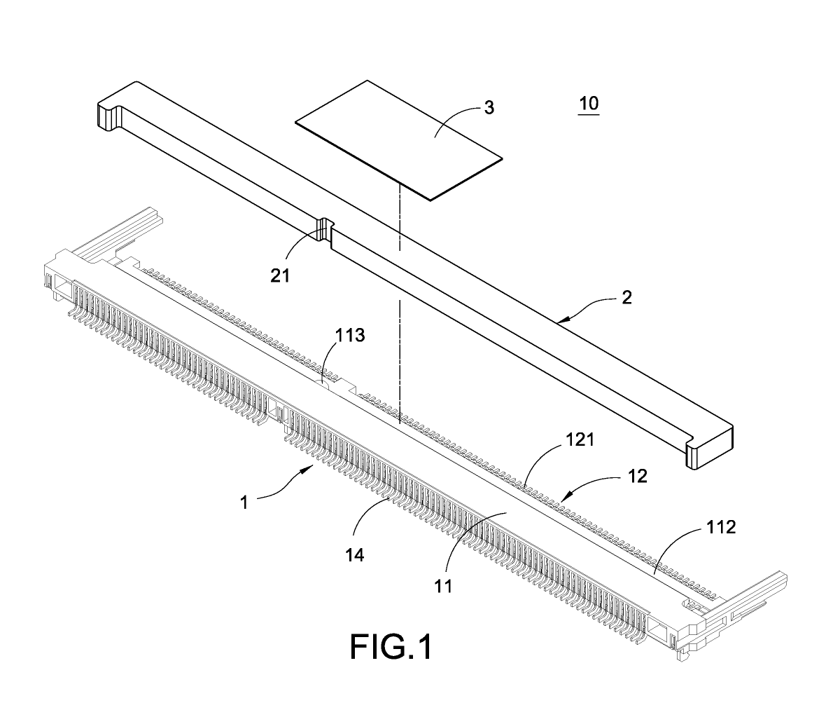

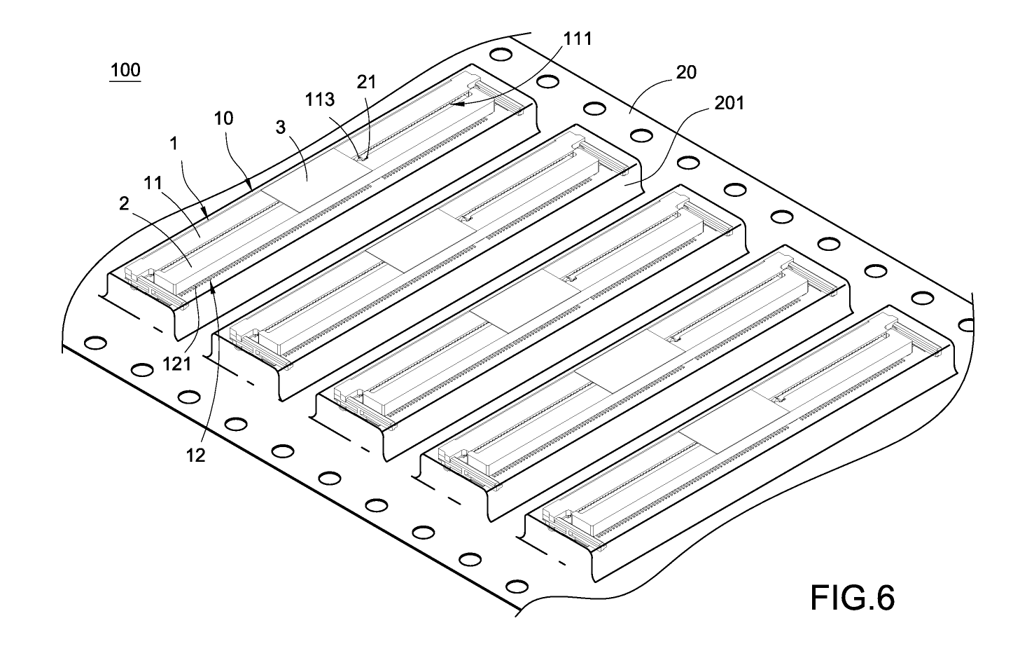

Please refer to FIG. 1 and FIG. 6, showing a first embodiment of a connector tape and a connector module thereof of the present invention. The connector module 10 mainly comprises a connector 1 and a detachable counter weight block 2; the connector tape 100 comprises a substrate 20 and a plurality of connector modules 10.

As shown in FIG. 1 to FIG. 3, the connector 1 is a latch connector but is not limited to such type only, and the connector 1 can be any type of connector.

The connector 1 comprises an insulative main body 11 and a plurality of conductive terminals 12; teach conductive terminal 12 includes a soldering portion 121 exposed on the insulative main body 11.

To be more specific, the insulative main body 11 includes an insertion slot 111; each conductive terminal 12 is a lower terminal 13; each lower terminal 13 is disposed at a lower portion inside the insertion slot 111, and the soldering portion 121 is formed at an end portion of the lower terminal 13 exposed out of the insertion slot 111.

In addition, the insulative main body 11 includes a positioning member 112. A mid-section 131 of each lower terminal 13 penetrates through and is positioned on the positioning member 112 in order to restrict each lower terminal 13 to be on the predefined location.

Furthermore, the connector 1 further comprises a plurality of upper terminals 14 secured onto the insulative main body 11. One end of each upper terminal 14 is exposed on the insulative main body 11 and another end thereof is disposed on an upper portion inside the insertion slot 111 in order to allow each upper terminal 14 and each lower terminal 13 to be arranged correspondingly in a top-down manner.

The detachable counter weight block 2 is detachably connected to the insulative main body 11, which means that the detachable counter weight block 2 can be assembled on or detached from the insulative main body 1, and the detachable counter weight block 2 exerts a gravitational force of weight onto each soldering portion 121 via the insulative main body 11; wherein the detachable counter weight block 2 can be of a geometric shape of a rectangular shape and an elongated shape. In addition, the detachable counter weight block 2 can be made of any material of high specific weight in order to allow the weight of the detachable counter weight block 2 to reach the predefined value.

In the embodiment, the detachable counter weight block 2 is detachably connected to the insulative main body 11 by using the method that wherein the connector module 10 of the present invention further comprises an adhesive tape 3, and the detachable counter weight block 2 abuts against the insulative main body 11 while the adhesive tape 3 is attached to the detachable counter weight block 2 and the insulative main body 11 correspondingly.

In addition, a most preferable embodiment is as follows. The detachable counter weight block 2 abuts against an upper portion of the positioning block 112, and the adhesive tape 3 is attached to the detachable counter weight block 2 and the top portion of the insulative main body 11. However, the present invention is not limited to such configuration only but can be modified based on the needs of an actual situation.

Furthermore, the insulative main body 11 includes an error-proof protruding rib 113 extended therefrom and disposed between the lower terminals 13. The detachable counter weight block 2 includes a notch 21, and the notch 21 is inserted with the error-proof protruding rib 113 correspondingly.

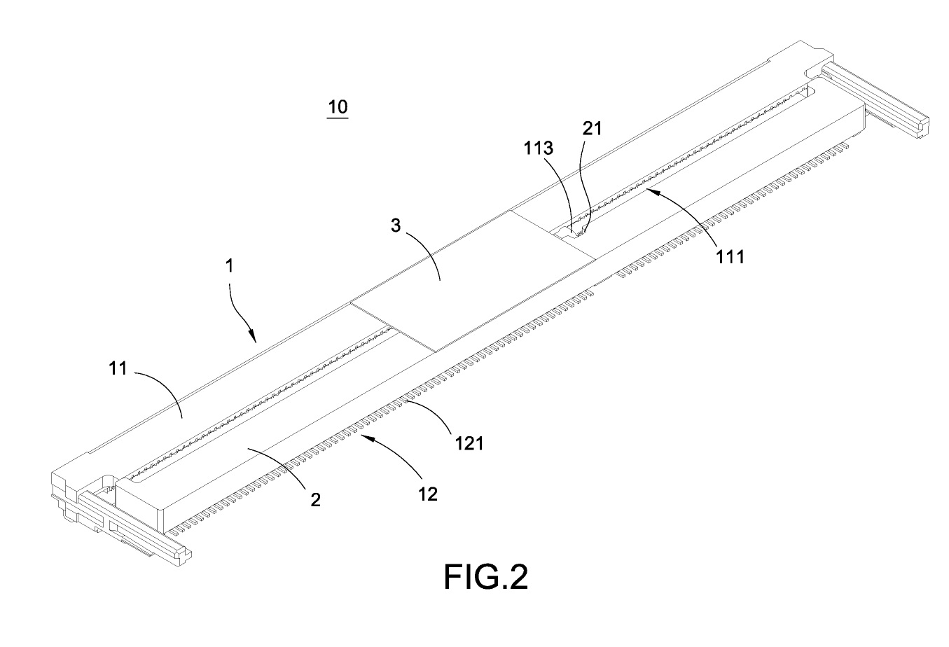

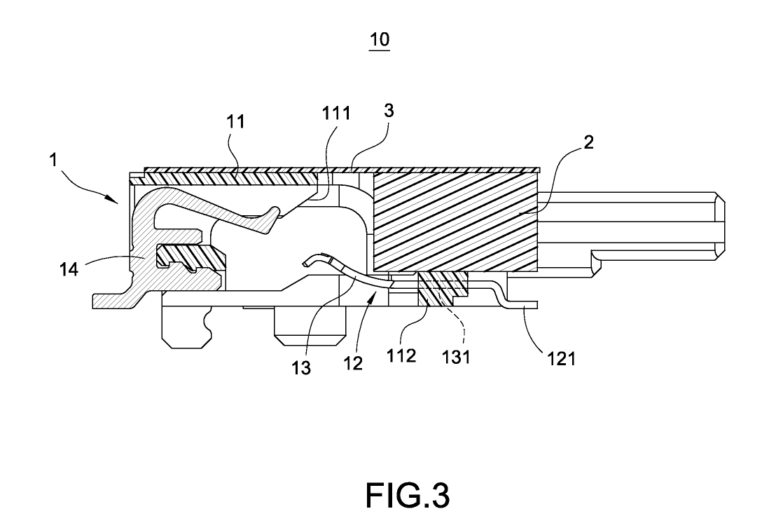

The assembly of the connector module 10 of the present invention, as shown in FIG. 2 to FIG. 3, utilizes the connector 1 comprising the insulative main body 11 and the plurality of conductive terminals 12 secured on the insulative main body 11, and each conductive terminal 12 includes the soldering portion 121 exposed on the insulative main body 11; the detachable counter weight block 2 is detachably connected to the insulative main body 11; the detachable counter weight block 2 exerts a gravitational force of weight on each one of the plurality of soldering portions 121 via the insulative main body 11. With such configuration, the detachable counter weight block 2 is detachably connected to the insulative main body 11 in order to allow the detachable counter weight block 2 to exert a gravitational force of weight on the soldering portions 121 during the later process of the assembly of the connector 1 and the circuit board 30 such that the soldering portions 121 can be stably soldered onto the circuit board 30. Furthermore, once the assembly of the connector 1 and the circuit board 30 is complete, the detachable counter weight block 2 can be easily detached from the insulative main body 11 in order to achieve the merits of cost-saving with simplified steps for the assembly of the connector 1.

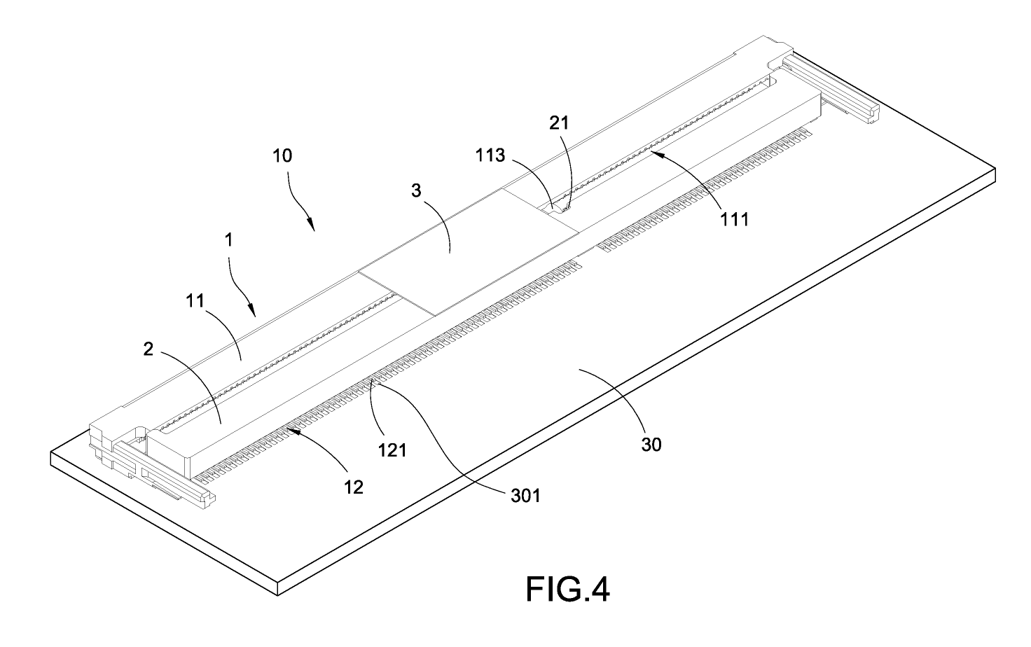

For the state of use of the connector module 10 of the present invention, first, as shown in FIG. 4, the connector module 10 is disposed on the edge of the circuit board 30 correspondingly, and the circuit board 30 includes a plurality of contact points 301. When the detachable counter weight block 2 is assembled onto the insulative main body 11, the detachable counter weight block 2 can exert a gravitational force of weight on the soldering portions 121 in order to allow each soldering portion 121 to be stably attached to each contact point 301 correspondingly such that the soldering portions 121 and the corresponding contact points 301 can be firmly soldered onto each other. Accordingly, a simple unit can be used to facilitate the assembly of the connector 1 and the circuit board 30; therefore, the connector module 10 of the present invention has the merits of low assembly cost.

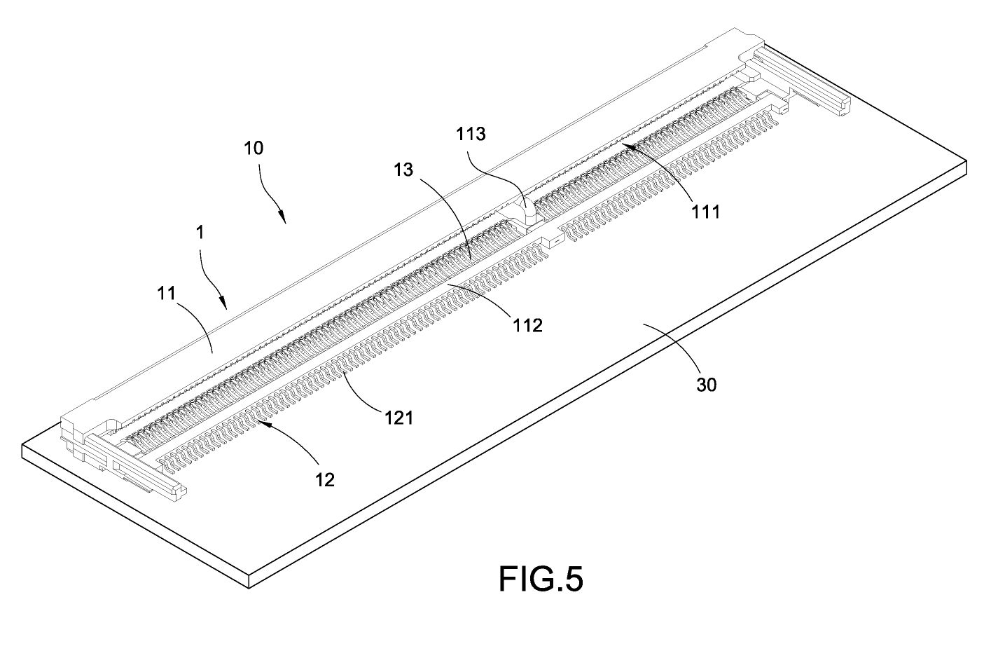

Furthermore, as shown in FIG. 5, once the assembly of the connector 1 and the circuit board 30 is complete, which means that the soldering portions 121 are completely soldered onto the corresponding contact points 301, the assembly personnel can tear off the adhesive tape 3 in order to detach the detachable counter weight block 2 from the insulative main body 1 with ease and to complete the finishing product. Accordingly, simple steps are used to complete the assembly of the connector 1 and the circuit board 30; therefore, the connector module 10 of the present invention has the merits of simplified steps for assembly.

Moreover, there are redundant materials to be discarded in the known assembly of connector and circuit board; in comparison, the detachable counter weight block 2 detached form the connector module 1 of the present invention can be re-used, and the detachable counter weight block 2 can be assembled onto another connector 1 in order to form a new set of connector module 10; therefore, the assembly cost of the connector module 10 of the present invention is even more cheaper.

As shown in FIG. 6, the connector tape 100 comprises a substrate 20 and a plurality of the connector modules 10 mentioned above. The substrate 20 includes a plurality of receiving slots 201; each connector module 10 is received and sealed inside each receiving slot 201 respectively. Accordingly, the manufacturer can ship the connector tapes 100 to the customer in order to facilitate the planning of the storage, shipping and management of the connector modules 10.

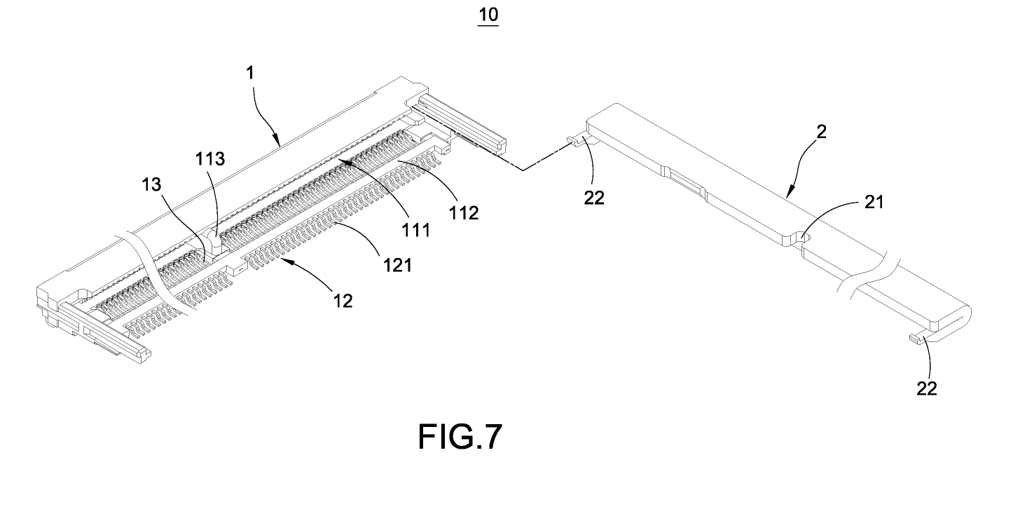

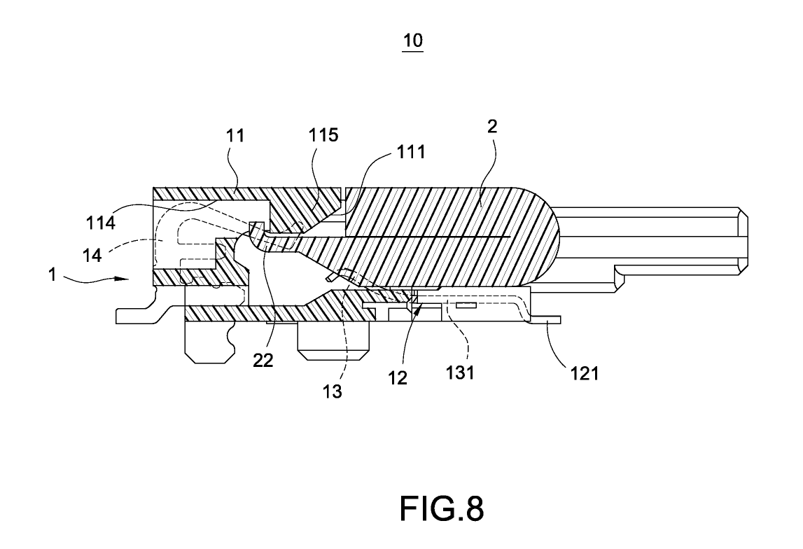

Please refer to FIG. 7 to FIG. 8, showing a second embodiment of the connector module 10 of the present invention. The second embodiment is generally identical to the first embodiment; the second embodiment differs from the first embodiment in that its method of connecting the detachable counter weight block 2 to the insulative main body 11 is different.

To be more specific, the insulative main body 11 includes a top wall 114 formed inside the insertion slot 111, and the top wall 114 includes a protrusion 115 extended therefrom. The detachable counter weight block 2 includes at least one L-shape locking hook 22 extended therefrom; the detachable counter weight block 2 abuts against an upper portion of the positioning member 112, and the L-shape locking hook 22 is inserted into the insertion slot 111 and locked onto the protrusion 115 correspondingly. Therefore, it is able to achieve the same function and effect mentioned above.

Similarly, for the connector tape 100 as shown in FIG. 6, the receiving slot 201 of the substrate 20 is able to receive and seal the connector module 10 of the second embodiment therein as well.

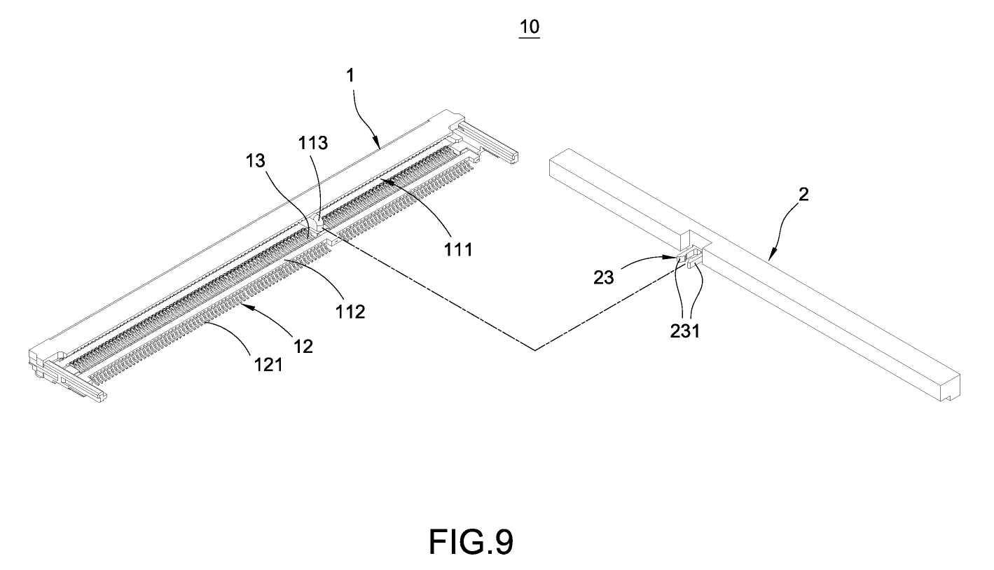

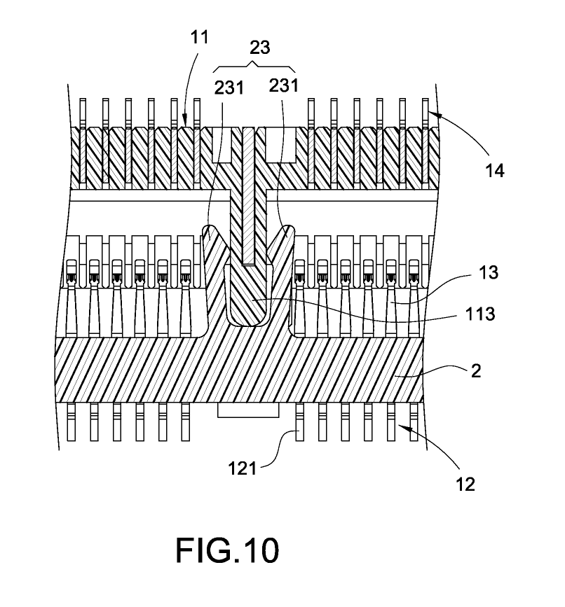

Please refer to FIG. 9 to FIG. 10, showing a third embodiment of the connector module 10 of the present invention. The third embodiment is generally identical to the first embodiment; the third embodiment differs from the first embodiment in that its method of connecting the detachable counter weight block 2 to the insulative main body 11 is different.

To be more specific, the detachable counter weight block 2 includes a clamping portion 23 extended therefrom and corresponding to the notch 21; the detachable counter weight block 2 abuts against an upper portion of the positioning member 112; the notch 21 is inserted with the error-proof protruding rib 113, and the clamping portion 23 is locked with the error-proof protruding rib 113 correspondingly; wherein the clamping portion 23 is formed by a pair of hooks 231 extended from the insulative main body 11, and the error-proof protruding rib 113 is clamped between the pair of hooks 231. Therefore, it is able to achieve the same function and effect mentioned above.

Similarly, for the connector tape 100 as shown in FIG. 6, the receiving slot 201 of the substrate 20 is able to receive and seal the connector module 10 of the third embodiment therein as well.

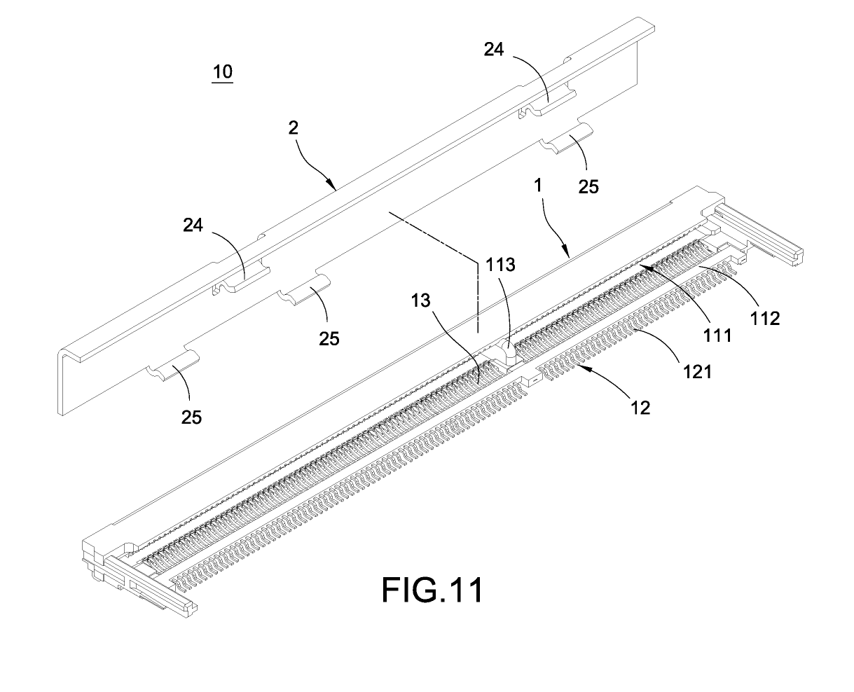

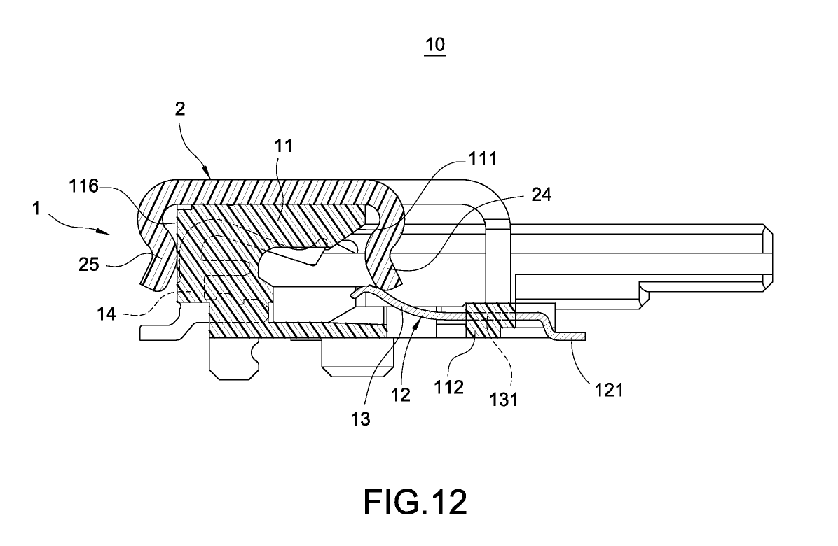

Please refer to FIG. 11 to FIG. 12, showing a fourth embodiment of the connector module 10 of the present invention. The fourth embodiment is generally identical to the first embodiment; the fourth embodiment differs from the first embodiment in that its method of connecting the detachable counter weight block 2 to the insulative main body 11 is different.

To be more specific, the insulative main body 11 includes a rear wall 116 formed on one side away from the insertion slot 111. The detachable counter weight block 2 includes at least one first locking hook 24 and at least one second locking hook 25; the detachable counter weight block 2 abuts against an upper portion of the insulative main body 11; the first locking hook 24 is inserted into the insertion slot 111 correspondingly, and the second locking hook 25 is locked onto the rear wall 116 correspondingly. Therefore, it is able to achieve the same function and effect mentioned above.

Similarly, for the connector tape 100 as shown in FIG. 6, the receiving slot 201 of the substrate 20 is able to receive and seal the connector module 10 of the fourth embodiment therein as well.

In view of the above, the connector tape and the connector module thereof of the present invention is able to achieve the objective of the expected uses and overcome the drawbacks of known arts while satisfying the requirement of the patentability including industrial applicability, novelty and inventive step, which is legitimately applied for the grant of a patent right.

What is claimed is:

1. A connector module comprising:
a connector comprising an insulative main body and a plurality of conductive terminals secured on the insulative main body; each one of the conductive terminals having a soldering portion exposed out of the insulative main body; and
a detachable counter weight block detachably connected to the insulative main body; the detachable counter weight block configured to exert a gravitational force of weight on the plurality of soldering portions via the insulative main body.

2. The connector module according to claim 1, wherein the insulative main body includes an insertion slot; each one of the conductive terminals is a lower terminal; the plurality of lower terminals are disposed at a lower portion inside the insertion slot, and the soldering portion is formed at an end portion of the lower terminal exposed out of the insertion slot; the connector further comprises a plurality of upper terminals secured onto the insulative main body; one ends of the plurality of upper terminals are exposed on the insulative main body and another ends thereof are disposed at an upper portion inside the insertion slot.

3. The connector module according to claim 2, wherein the insulative main body includes a positioning member disposed at a front end of the insertion slot; mid-sections of the plurality of lower terminals penetrate through and are positioned inside the positioning member.

4. The connector module according to claim 3, further comprising an adhesive tape; the detachable counter weight block abuts against an upper portion of the positioning member, and the adhesive tape is attached to the detachable counter weight block and the top portion of the insulative main body correspondingly.

5. The connector module according to claim 1, further comprising an adhesive tape; the detachable counter weight block abuts against the insulative main body, and the adhesive tape is attached to the detachable counter weight block and the insulative main body correspondingly.

6. The connector module according to claim 3, wherein the insulative main body includes a top wall formed inside the insertion slot; the top wall includes a protrusion extended therefrom; the detachable counter weight block includes at least one L-shape locking hook extended therefrom; the detachable counter weight block abuts against an upper portion of the positioning member, and the L-shape locking hook is inserted into the insertion slot correspondingly.

7. The connector module according to claim 2, wherein the insulative main body includes an error-proof protruding rib extended therefrom and disposed between the plurality of lower terminals; the detachable counter weight block includes a notch formed thereon, and the notch is inserted with the error-proof protruding rib correspondingly.

8. The connector module according to claim 3, wherein the insulative main body includes an error-proof protruding rib extended therefrom and disposed between the plurality of lower terminals; the detachable counter weight block includes a notch formed thereon and a clamping portion extended therefrom corresponding to the notch; the detachable counter weight block abuts an upper portion of the positioning member, and the notch is inserted with the error-proof protruding rib correspondingly, the clamping portion is locked onto the error-proof protruding rib correspondingly.

9. The connector module according to claim 8, wherein the clamping portion is formed by a pair of hooks extended from the insulative main body, and the error-proof protruding rib is clamped between the pair of hooks.

10. The connector module according to claim 2, wherein the insulative main body includes a rear wall formed on one side away from the insertion slot; the detachable counter weight block includes at least one first locking hook and at least one second locking hook extended therefrom; the detachable counter weight block abuts against an upper portion of the insulative member, the first locking hook is inserted into the insertion slot correspondingly, and the second locking hook is locked onto the rear wall correspondingly.

11. A connector tape comprising:
a substrate having a plurality of receiving slots; and
a plurality of connector module; each connector module respectively received and sealed inside each receiving slot; the connector module comprising:
a connector comprising an insulative main body and a plurality of conductive terminals secured on the insulative main body; each one of the conductive terminals having a soldering portion exposed out of the insulative main body; and
a detachable counter weight block detachably connected to the insulative main body; the detachable counter weight block configured to exert a gravitational force of weight on the plurality of soldering portions via the insulative main body.

12. The connector tape according to claim 11, wherein the insulative main body includes an insertion slot; each one of the conductive terminals is a lower terminal; the plurality of lower terminals are disposed at a lower portion inside the insertion slot, and the soldering portion is formed at an end portion of the lower terminal exposed out of the insertion slot; the connector further comprises a plurality of upper terminals secured onto the insulative main body; one ends of the plurality of upper terminals are exposed on the insulative main body and another ends thereof are disposed at an upper portion inside the insertion slot.

13. The connector tape according to claim 12, wherein the insulative main body includes a positioning member disposed at a front end of the insertion slot; mid-sections of the plurality of lower terminals penetrate through and positioned inside the positioning member.

14. The connector tape according to claim 13, further comprising an adhesive tape; wherein the detachable counter weight block abuts against an upper portion of the positioning member, and the adhesive tape is attached to the detachable counter weight block and the top portion of the insulative main body correspondingly.

15. The connector tape according to claim 11, further comprising an adhesive tape; wherein the detachable counter weight block abuts against the insulative main body, and the adhesive tape is attached to the detachable counter weight block and the insulative main body correspondingly.

16. The connector tape according to claim 13, wherein the insulative main body includes a top wall formed inside the insertion slot; the top wall includes a protrusion extended therefrom; the detachable counter weight block includes at least one L-shape locking hook extended therefrom; the detachable counter weight block abuts against an upper portion of the positioning member, and the L-shape locking hook is inserted into the insertion slot correspondingly.

17. The connector tape according to claim 12, wherein the insulative main body includes an error-proof protruding rib extended therefrom and disposed between the plurality of lower terminals; the detachable counter weight block includes a notch formed thereon, and the notch is inserted with the error-proof protruding rib correspondingly.

18. The connector tape according to claim 13, wherein the insulative main body includes an error-proof protruding rib extended therefrom and disposed between the plurality of lower terminals; the detachable counter weight block includes a notch formed thereon and a clamping portion extended therefrom corresponding to the notch; the detachable counter weight block abuts an upper portion of the positioning member, and the notch is inserted with the error-proof protruding rib correspondingly, the clamping portion is locked onto the error-proof protruding rib correspondingly.

19. The connector tape according to claim 18, wherein the clamping portion is formed by a pair of hooks extended from the insulative main body, and the error-proof protruding rib is clamped between the pair of hooks.

20. The connector tape according to claim 12, wherein the insulative main body includes a rear wall formed on one side away from the insertion slot; the detachable counter weight block includes at least one first locking hook and at least one second locking hook extended therefrom; the detachable counter weight block abuts against an upper portion of the insulative member, the first locking hook is inserted into the insertion slot correspondingly, and the second locking hook is locked onto the rear wall correspondingly.
